(19) United States
(12) Patent Application Publication
(10) Pub. No.: US 2024/0165761 A1
(43) Pub. Date: May 23, 2024

(54) TOOL MAGAZINE

(71) Applicant: Gebr. Heller Maschinenfabrik GmbH, Nürtingen (DE)

(72) Inventors: Jochen Kern, Gomaringen (DE); Lars Kant, Leonberg (DE); Thomas Haussmann, Oberboihingen (DE); Jan Langer, Aichtal (DE)

(21) Appl. No.: 18/511,173

(22) Filed: Nov. 16, 2023

(30) Foreign Application Priority Data
Nov. 17, 2022 (DE) 10 2022 130 425.6

(51) Int. Cl. B23Q 3/155; B23Q 3/157

(52) U.S. Cl. CPC B23Q 3/15534; B23Q 3/15773

(57) ABSTRACT

A tool magazine including a rack type tool storage device in which all tools are horizontally arranged along a transport passage facing away from a machine tool. A loader links the tool magazine with the machine tool. For this purpose, the loader comprises a linear drive device for a horizontal movement along the transport passage as well as another linear drive device for a vertical movement inside the transport passage. In addition, the loader includes a pivot arm, which can be pivoted around the vertically orientated pivot axis by means of a pivot drive. On its free end the pivot arm supports a gripper, which is specifically pivotably supported around a vertical second pivot axis on the arm. A control device coordinates the two linear drives and the two pivot drives, so that tools can be transferred first out of the tool storage device into tool removal passages provided therein and then into the transport passage.

### CROSS REFERENCE TO RELATED APPLICATIONS

This application claims priority under 35 U.S.C. § 119 to the following German Patent Application No. 10 2022 130 425.6, filed on Nov. 17, 2022, the entire contents of which are incorporated herein by reference thereto.

### TECHNICAL FIELD

The present disclosure refers to a tool magazine for a machine tool, particularly a machine tool for chip removing machining of workpieces, particularly machine tools for metal machining.

### BACKGROUND

Machine tools are frequently linked with tool magazines in which tools in a larger number are provided. The tools typically provided with tool support are automatically inserted into or removed from the work spindle of the machine tool during the progress of the machining of workpieces and replaced by other tools. The machine tool allows in cooperation with the tool magazine an automatic machining of workpieces. This principle is widely spread, particularly in metal machining.

A tool magazine for being linked with a machine tool is known from EP 2 251 138 B1, comprising a tool storage device and a loader assigned thereto. The loader is configured to transfer tools from their storage position in the magazine into a take-over position in which a common two-forked tool changer takes over the tool in order to transfer it to a work spindle of the machine tool or from there to the loader. The loader is thereby configured to carry out a horizontal movement in x-direction orientated orthogonal to the rotation axis of the tool changer and in addition a movement in the vertical y-direction. In addition, the loader comprises a telescopic drive, in order to move the tool in a horizontal z-direction orientated orthogonal to the two directions mentioned above. The tools are also orientated with their center axes in z-direction, which is parallel to the rotation direction of the tool changer.

EP 3 061 562 B1 discloses a machine tool linked with a tool magazine having a work spindle, which can be transferred in vertical direction. Here the tool changer also comprises a vertical rotation axis. The tool magazine stores all tools in a hanging manner, i.e. with vertical center axis. For transfer of tools from the magazine into the tool changer, a two-axis loader is provided that comprises a carriage, which can be moved in vertical direction Y and in longitudinal direction Z. The carriage carries a pivot arm, which is pivotably supported around the vertical axis and comprises a holder for tool supports on its free end.

DE 10 2011 088 055 A1 also discloses a machine tool linked with a tool magazine. The tool magazine comprises a tool storage with tools orientated in a lying manner, i.e. horizontally orientated tools and in addition tools orientated in a hanging manner. A tool-rotating table having a horizontal rotation axis is assigned to the tool storage, whereby a loader is configured to transfer the tools from the tool storage into the tool-rotating table (and back). For handing over of tools between the tool-rotating table and the machine tool, a common tool changer having two holding forks is provided.

The required space of tool magazines is considered more and more critically.

### BRIEF SUMMARY

Therefore, it is the object of the present disclosure to provide a concept for a tool magazine, which has a good utilization of the space existing in proximity to a machine tool.

Disclosed is a tool magazine for a machine tool, the machine tool for chip removing machining of workpieces made of metal, including: a first tool storage device, which is configured for storing tools in in a horizontal first direction, a loader comprising an arm, which is movable in a vertical second direction transverse to the horizontal first direction as well as in a horizontal third direction and which can be pivoted around a first pivot axis, which is orientated in the vertical second direction, and wherein the arm supports a gripper at an end of the arm located away from the first pivot axis, wherein the gripper is pivotably supported on the arm around a vertical second pivot axis.

The tool magazine according to the present disclosure uses the space existing at a flank of the machine tool without remarkably increasing the required transverse distance to an adjacent machine tool or another installation. For this purpose, the space along the flank of the machine tool is utilized well. This is achieved in that the tools are provided in the tool magazine in a tool storage device horizontally having an orientation transverse to the machine tool, i.e. facing away from the flank of the machine tool. Between the tool storage device and the machine tool a transport passage is formed in which a loader is arranged. The latter comprises an arm, which is pivotably supported around a vertically orientated first pivot axis. On its free end the arm carries a gripper that is configured to grip or release a tool support. The gripper is pivotably supported on the arm around a vertical second pivot axis. In addition, the arm can be moved horizontally along the flank of the machine tool in a horizontal direction Z as well as in a vertical direction Y. With this concept a large number of tools can be provided in case of small, particularly narrow installation space. The required installation width of the tool magazine is limited to a length of the stored tools plus a narrow transport passage for the transport of the tools from their storage position to the tool changer and back. Due to the provided pivot axis, the tool can be orientated in the transport passage in longitudinal manner relative to the passage, i.e. it can be orientated in z-direction, so that the passage can be kept narrow.

By means of the concept, according to the present disclosure, of arrangement of tools in a tool storage device facing horizontally away from a machine tool and a loader arranged in a transport passage between the machine tool and the tool storage device having two linear axes x and y as well as two pivot axes A and B, magazines are provided having high clearness, short exchange times and require little space. Particularly such tool magazines are narrow in x-direction and thus optimally fit in the machine arrangement concept in which lateral machine distances can be kept short.

The arm of the loader can be configured as a single member type. In this case, it does not have an additional hinge between its first pivot axis A and the second pivot axis B, but is preferably rather configured in a rigid and also non-telescopic manner. Further, preferably the first and second pivot axis are orientated parallel to one another. The movement of tools by means of the loader out of the tool storage device is thereby carried out without changing height by means of the pivot axis first. Therefore, the pivot drives only have to be dimensioned for managing the required acceleration and deceleration forces, but not for overcoming weights.

The tool storage device can have vertical walls that comprise on its two vertical edges muzzle-like cutouts for storage of tools or tool supports. The muzzle-like cutouts preferably comprise opening directions facing away from one another. They can particularly open slightly increasingly. Between the walls, preferably arranged in a common plane, passages are provided, which form removal passages for the tools. It is also possible to make the removal passages so wide that the tools can already be slightly pivoted around a vertical axis when they are transferred in x-direction from the storage position into the transport passage. Due to this technique, it is possible to make the transport passage narrower than the total tool length, whereby the required space for the tool magazine in x-direction is minimized.

In a preferred embodiment the tool storage device is divided into an immovable section and a movable section. The movable section can be configured as carriage, which can be moved in longitudinal direction of the tools relative to the immovable section of the tool storage device. In this manner the storage process of the tool magazine can be simplified and accelerated.

In addition, the tool magazine can comprise a complement magazine having a second tool storage device. This second tool storage device can be configured for storing of tools in horizontal position, however, orthogonal to the tools of the first tool storage device. In this manner tools being particularly long in x-direction can be stored in a space-saving manner. In addition, the tool magazine and/or the complement magazine can be provided with a loading station. For example, the latter can be rotatably arranged around a vertical axis and can comprise tool holders for horizontal storage of tools. Particularly the loading station can be configured so that tools or tool holders provide access for a handling device, such as a crane.

### BRIEF DESCRIPTION OF THE DRAWINGS

Additional details of advantageous embodiments of the present disclosure are subject of dependent claims as well as the drawings and/or the description. The drawings show:

FIG. 1 a machine tool having a tool magazine in schematic perspective illustration,

FIG. 2 the tool magazine and the machine tool according to FIG. 1 in schematic sectional top view,

FIGS. 3 to 5 the tool magazine in top view in different states,

FIG. 6 the tool magazine in a perspective simplified back view,

FIG. 7 the loader of the tool magazine in a simplified perspective illustration.

### DETAILED DESCRIPTION

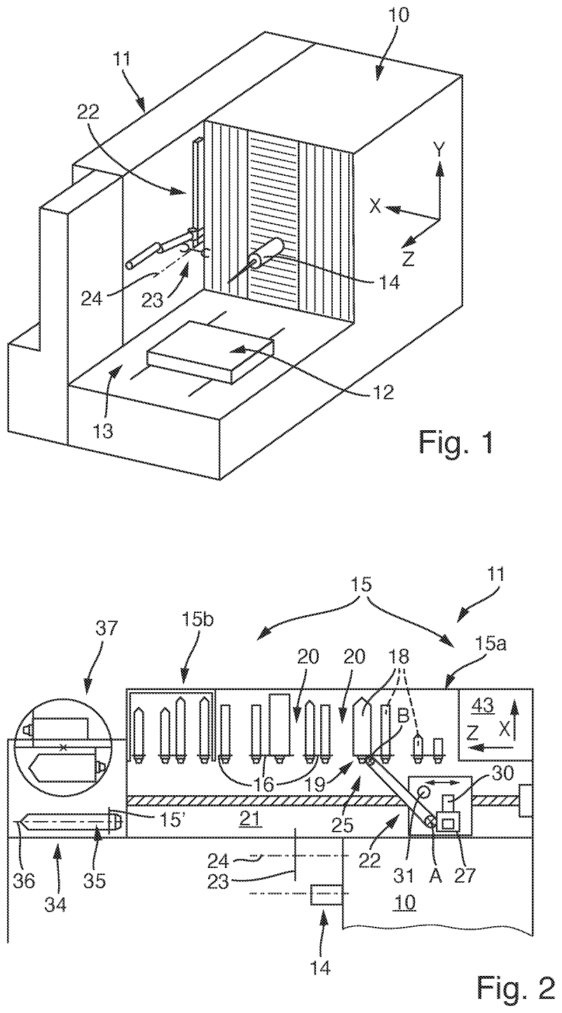

In FIG. 1 a tool magazine 11 is illustrated, which is linked with a machine tool 10, wherein the tool magazine 11 is arranged at a flank of machine tool 10. The machine tool 10 comprises a workpiece holder 12, which can be immovable or movable and which is arranged in a work space 13 of machine tool 10. Inside work space 13 also at least one work spindle 14 is arranged having a non-illustrated chuck or holder for a tool as well as a rotating drive. The rotation axis of the work spindle 14 is arranged orthogonal relative to a first horizontal direction, which is the x-direction, as well as orthogonal to a vertical direction, which is the y-direction. The rotation axis preferably corresponds to the z-direction orientated orthogonal relative to the x-direction and the y-direction. As necessary, work spindle 14 can be arranged in a manner to be inclined as well as movable in X and y-direction. The workpiece holder 12 can be arranged to be movable in z-direction, for example, and can be arranged to be movable in other directions or to be rotatable or pivotable, for example. The flank of the machine tool extends in X and x-direction.

The tool magazine 11 is located in x-direction laterally next to machine tool 10 and extends preferably along the total length of the machine tool 10 in z-direction or at least a remarkable part thereof, as schematically illustrated in FIG. 2. In addition, tool magazine 11 extends along the total height of the machine tool 10 in y-direction or at least a remarkable portion thereof, as illustrated in FIG. 1. Alternatively, tool magazine 11 can also extend beyond machine tool in y-direction or in z-direction.

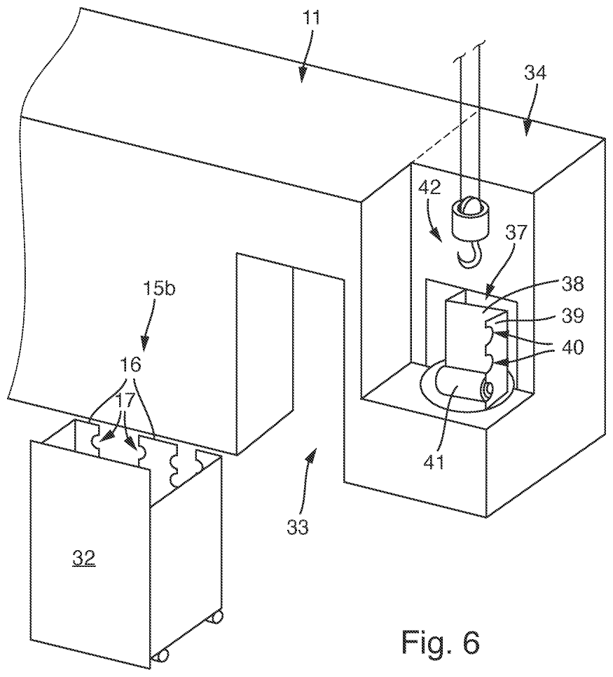

Tool magazine 11 comprises a first tool storage device 15 having an immovable section 15a and at least, as an option, a movable section 15b. Walls 16 are provided in a common y-z-plane on the immovable section 15a as well as on the movable section 15b, wherein the walls 16 have muzzle-like cutouts 17 in their edges extending in y-direction, as depicted by FIG. 6. The cutouts 17 of adjacent walls 16 are preferably arranged facing one another and with slightly increasing opening direction (compare FIG. 6 using the example of the movable section 15b). The muzzle-like cutouts 17 serve for storing tool supports, in which tools 18 are held. The tool supports can have arbitrary connection devices for the work spindle 14 according to a standard, e.g. hollow shank taper or steep taper shank or the like. Due to the orientation and configuration of the walls 16, the tool storage device 15 is configured for storing the tools 18 in horizontal orientation. The tools 18 of the entire tool storage device 15 are orientated with their rotation or center axes in x-direction and thus orthogonal relative to the rotation axis of the work spindle 14.

In a preferred embodiment the walls 16 are arranged with different long distances relative to one another in z-direction. In case of long distances, the width of the removal passage 20 is increased so that particularly long tools can be stored in the cutouts 17 of the adjacent walls 16, especially tools having a particularly large diameter. In case of smaller distances of the walls 16, tools having normal size can be stored in the cutout 17. However, a high capacity for storing tools and thus a high storing density is achieved with smaller distances.

Removal passages 20 are provided between adjacent walls 16 through which a tool 18 can be transferred from the tool storage device 15 into the transport passage 21. While the removal passages 20 extend in x-direction, the transport passage 21 extends in z-direction.

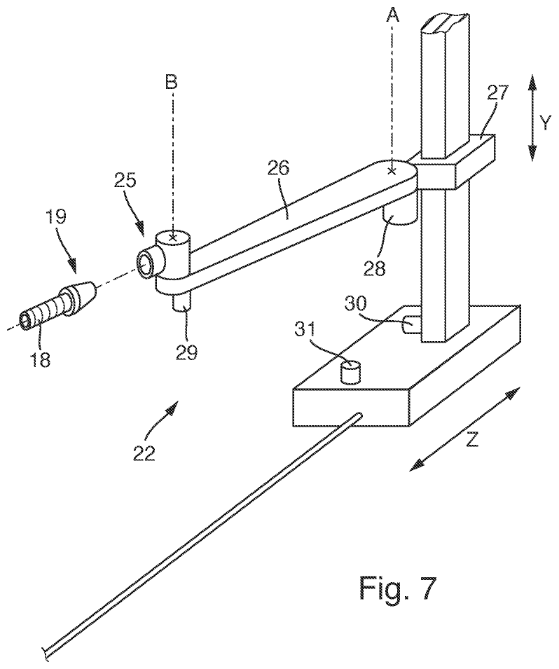

A loader 22 individually illustrated in FIG. 7 and a tool changer 23 schematically indicated in FIG. 1 serve to remove tools 18 out of the tool storage device 15 and for transfer into the work spindle 14 of machine tool 10. The tool changer 23 comprises arms pivotably supported around a pivot axis 24, which is, for example, orientated in z-direction, wherein the arms comprise fork-like or halfmoon-like holders for the tool supports of the tools 18 at their ends. The tool changer 23 serves for transfer of tools 18 from loader 22 into work spindle 14 and vice versa. The pivot axis 24 is preferably orientated parallel to the rotation axis of work spindle 14. If work spindle 14 comprises a rotation axis with variable orientation, it is orientated parallel to the pivot axis 24 for the tool exchange.

As apparent from FIGS. 2 and 7, loader 22 comprises a gripper 25 that can be configured, for example, to come into engagement with connection device 19 of the tool support. The gripper 25 is held on a free end of one arm 26 that itself is held on a slide 27 in a manner to be rotatable around a vertical pivot axis A. A pivot drive 28 is assigned to pivot axis A. The gripper 25 is pivotably held on the free end of arm 26 and can be pivotably adjusted specifically around a pivot axis B by means of a pivot drive 29. The slide 27 is vertically movable in y-direction by means of a linear guide and the positioning drive 30 and is movable in z-direction by means of another linear guide and the positioning drive 31. The movement path in z-direction extends preferably over the entire length of transport passage 21, so that the tools 18 located on the immovable section 15a of the tool storage device as well as tools 18 located on the movable section 15b of the tool storage device as well as the tools in the complement magazine 34 can be reached by gripper 25.

The movable section 15b of the tool storage device can be configured as carriage 32, which fits according to FIG. 6 in a respective opening 33 of tool magazine 11 and can be moved into and out of opening 33. In this manner it can be used to be equipped with tools outside tool magazine 11. These tools can then be transported by means of loader 22 to other locations, particularly also locations in the immovable section 15a of tool storage device 15. Vice versa tools out of the immovable section 15a can be transferred into the movable section 15b. The loader 22 can carry out this process during machining phases in which no tool exchange with machine tool 10 takes place.

The tool magazine 11 can comprise a complement magazine 34 that is preferably arranged at one end of transport passage 21. The complement magazine 34 is configured to store the tools, such as a tool 35, in horizontal orientation, however in a longitudinal orientation relative to the transport passage 21. Thereby the respective longitudinal axis 36 of the tool 35 is orientated in z-direction. In the complement magazine 34 multiple tools 35 can be arranged vertically above one another and also next to one another. These tools can be particularly long tools for which the space in the tool storage device 15 is insufficient. For example, the tool length in the tool storage device 15 can be limited to 800 mm, while in the complement magazine 34 remarkably longer tools can be stored and provided.

The complement magazine can comprise a loading station 37, as apparent from FIGS. 2 and 6. The loading station 37 can have a rotary table, which can be rotated around a vertical axis and on which a tool storage device 38 for storing one or multiple tools can be arranged. The tool storage device 38 can in turn have vertical walls 39 with muzzle-like cutouts 40 that open slightly increasingly in order to locate tool supports therein. Thereby a part of the loading station extends into the environment, as apparent from FIGS. 2 and 6, so that a tool 41 stored there is accessible for an operator as well as from the top for a handling device, such as a crane, which is indicated in FIG. 6 only by means of a crane hook 42.

The tool magazine 11 described so far operates in cooperation with the machine tool 10 as follows:

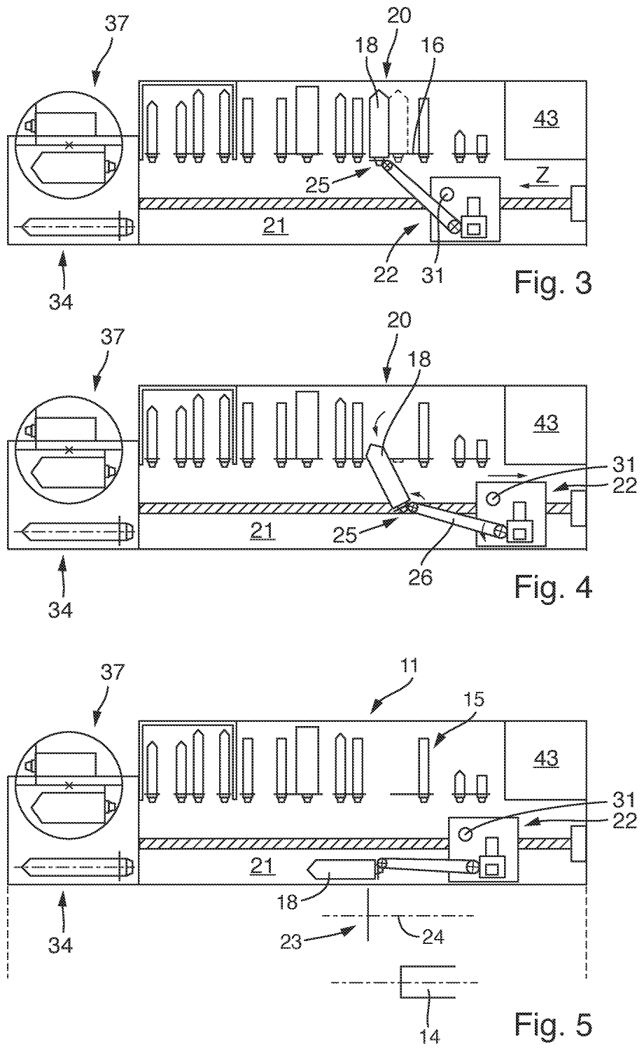

For the function description it is first assumed that the entire tool magazine 11 is equipped with tools 18, 35, as illustrated. For example, if now tool 18 illustrated in FIG. 2 in highlighted manner shall be transferred into the work spindle, the loader 22 first couples with its gripper 25 to the tool support of tool 18. If this has happened, tool 18 is transported, as indicated in FIG. 3, by means of a short movement of loader 22 and thus its gripper 25 in z-direction and if necessary, slightly in y-direction out of tool storage device 15 and thus out of the respective opening in the wall 16. The tool 18 is now provided in removal passage 20 ready for transfer in the transport passage 21. For this, a control device 43, which all positioning and pivot drives 28, 29, 30, 31 are connected, controls these drives so that concurrently arm 26 is pivoted in direction toward transport passage 21 and thereby gripper 25 is rotated so that tool 18, which is still partly located in removal passage 20, starts to turn into transport passage 21. Concurrently, positioning drive 31 is activated so that loader 22 is moved in z-direction (to the right in FIG. 4), as indicated in FIG. 4, so that the part of tool 18, which is still in removal passage 20 does not collide with other tools. At the end of this action the state, according to FIG. 5, is achieved. The tool 18 is now longitudinally positioned inside transport passage 21 with its center axis orientated in z-direction. In this position it can be taken over by tool changer 23 and can be transferred into work spindle 14 by means of rotation around pivot axis 24 of the tool changer. If necessary, in order to supply tool 18 to the tool changer 23, the tool 18 can be positioned in x-direction by means of inverse control of pivot drives 28, 29 and thus be handed over to tool changer 23.

The loader 22 can be vice versa used to transfer tool 18 to its usual storage location in the tool storage device 15 or also to other locations of tool magazine 11. Likewise loader 22 can be used to take over tools from the loading station 37 or from immovable locations of complement magazine 34 and to transfer them to the tool storage device 15 or vice versa.

The tool magazine 11, according to the present disclosure, comprises a rack-type tool storage device 15 in which all tools 18 are horizontally arranged and facing away from a machine tool 10 along a transport passage 21. A loader 22 links the tool magazine 11 and/or the complement magazine 34 with machine tool 10. For this purpose, loader 22 comprises a linear drive device 31 for a movement horizontally along transport passage 21 as well as another linear drive device 30 for a vertical movement inside transport passage 21. In addition, loader 22 comprises a pivot arm 26, which can be pivoted around a vertically orientated pivot axis A by means of a pivot drive 28. At its free end the pivot arm supports a gripper 25, which is specifically pivotably supported around a vertical second pivot axis B by means of pivot drive 29. Apart from the four drive devices, i.e. the two linear drive devices 30, 31 and the two pivot drives 28, 29, no additional drives for moving and positioning of gripper 25 are provided.

A control device 43 coordinates the two linear drives 30, 31 and the two pivot drives 28, 29, so that tools 18 can be transferred out of the tool storage device 15 first in the removal passages 20 provided therein and then into transport passage 21. During transfer out of the removal passage 20 into transport passage 21 tool 18 can already undergo a pivot movement. For this reason, transport passage 21 can be narrower than the sum of the tool length of tool 18 and the length of the gripper 25 of loader 22. The width of the tool magazine 11 to be measured starting at machine tool 10 in x-direction can therefore be smaller than the double length of the tool that has to be picked up out of the tool storage device 15. Longer tools 35 can be stored in a complement magazine 34 in which they are held and stored longitudinally relative to the transport passage 21.

### LIST OF REFERENCE SIGNS

10 machine tool
11 tool magazine
12 workpiece holder
13 work space
14 work spindle
15 first tool storage device
15a immovable section of tool storage device
15b movable section of tool storage device
15′ second tool storage device
16 wall
x-y vertical plane extending in x- and y-direction
17 cutout
18 tool
19 tool support and connection device
20 removal passages
21 transport passages
22 loader
23 tool changer
24 pivot axis of tool changer
25 gripper of loader 22
26 arm of loader 22
27 slide of loader 22
A first pivot axis
28 pivot drive pivot axis A of arm 26
B second pivot axis
29 pivot drive pivot axis A of gripper 25
30 positioning drive y
31 positioning drive z
32 carriage
33 opening
34 complement magazine
35 tool
36 longitudinal axis
37 loading station
38 tool storage device
39 walls
40 cutout
41 tool
42 crane hook

1. A tool magazine for a machine tool, the machine tool for chip removing machining of workpieces made of metal, comprising:
a first tool storage device, which is configured for storing tools in in a horizontal first direction,
a loader comprising an arm, which is movable in a vertical second direction transverse to the horizontal first direction as well as in a horizontal third direction and which can be pivoted around a first pivot axis, which is orientated in the vertical second direction, and
wherein the arm supports a gripper at an end of the arm located away from the first pivot axis, wherein the gripper is pivotably supported on the arm around a vertical second pivot axis.

2. The tool magazine according to claim 1, wherein the arm is configured in a single member type.

3. The tool magazine according to claim 1, wherein the vertical second pivot axis is orientated parallel to the first pivot axis.

4. The tool magazine according to claim 1, wherein the first tool storage device comprises vertical walls that are provided with muzzle-type cutouts for holding of tool supports at two vertical edges of the tool supports.

5. Tool magazine according to claim 4, wherein the muzzle-type cutouts of the two vertical edges of the tool supports have opening directions facing away from one another.

6. The tool magazine according to claim 4, wherein the vertical walls are arranged in a common vertical plane.

7. The tool magazine according to claim 4, wherein removal passages for the tools are provided between the vertical walls.

8. The tool magazine according to claim 1, wherein the first tool storage device comprises an immovable section and a movable section.

9. The tool magazine according to claim 8, wherein the movable section is realized by a carriage, which can be moved in the horizontal first direction relative to the immovable section of the first tool storage device.

10. The tool magazine according to claim 1, wherein the loader comprises a drive for linear movement of the arm in the vertical second direction and a drive for linear movement of the arm in the horizontal third direction and wherein the loader comprises a first pivot drive for pivoting the arm around the first pivot axis and a second pivot drive for pivoting the gripper around the second pivot axis.

11. The tool magazine according to claim 10, wherein the drive, the first pivot drive and the second pivot drive are connected to a control device that is configured to pivot the gripper around the second pivot axis during movement of the gripper in the horizontal first direction by means of the arm and to concurrently move the gripper in the horizontal third direction.

12. The tool magazine according to claim 1, further comprising a tool changer for linking the tool magazine with the machine tool.

13. The tool magazine according to claim 1, wherein the tool magazine comprises a complement magazine having a second tool storage device, which is configured for storage of tools in the horizontal third direction.

14. The tool magazine according to claim 13, wherein the complement magazine comprises a loading station.

15. A machining center consisting of a machine tool having a work spindle, that is rotatingly driven and which is arranged in a work space and a workpiece holder and a tool magazine according to claim 1 arranged next to the machine tool, as well as a tool changer for linking the machine tool with the tool magazine.

16. The tool magazine according to claim 2, wherein the vertical second pivot axis is orientated parallel to the first pivot axis.

17. The tool magazine according to claim 16, wherein the first tool storage device comprises vertical walls that are provided with muzzle-type cutouts for holding of tool supports at two vertical edges of the tool supports.

18. Tool magazine according to claim 17, wherein the muzzle-type cutouts of the two vertical edges of the tool supports have opening directions facing away from one another.

19. The tool magazine according to claim 18, wherein the vertical walls are arranged in a common vertical plane.

20. The tool magazine according to claim 19, wherein removal passages for the tools are provided between the vertical walls.
